(19) United States
(12) Patent Application Publication
(10) Pub. No.: US 2009/0148712 A1
(43) Pub. Date: Jun. 11, 2009

(54) VISCOELASTIC COMPOSITION AND DAMPER, AND RELATED METHODS

(76) Inventor: Hong Xiao, Farmington Hills, MI (US)

Correspondence Address: BERENATO, WHITE & STAVISH, LLC, 6550 ROCK SPRING DRIVE, SUITE 240, BETHESDA, MD, 20817, US

(21) Appl. No.: 12/028,199

(22) Filed: Feb. 8, 2008

Related U.S. Application Data
(60) Provisional application No. 60/992,419, filed on Dec. 5, 2007.

(51) Int. Cl. B32B 15/082; B32B 9/04; B29C 65/00; C08J 9/06

(52) U.S. Cl. 428/457; 428/411.1; 156/60; 521/83

(57) ABSTRACT

A viscoelastic composition, a panel constrained layer damper containing a viscoelastic layer and a constraining layer, and a damped structure all provided. The viscoelastic composition features an elastomeric polymeric component containing an ethylene vinyl acetate having a vinyl acetate content constituting about 60 weight percent or more of the ethylene vinyl acetate, a thermoplastic polymeric component such as an ethylene vinyl acetate with a vinyl acetate content constituting about 40 weight percent or less of the ethylene vinyl acetate, asphalt, filler, and a blowing agent.

### CROSS-REFERENCE TO RELATED APPLICATION

This application claims the benefit of priority of U.S. Provisional Application No. 60/992,419 filed Dec. 5, 2007, the complete disclosure of which is incorporated herein by reference.

### FIELD OF THE INVENTION

This invention relates to viscoelastic compositions, to panel constraining layer (PCL) dampers containing the viscoelastic compositions, to damped substrates, and to methods of making and using viscoelastic the same. The viscoelastic compositions embodied herein provide effective damping and stiffness for reducing noise and resonant vibrations over a broad range of temperatures. The viscoelastic compositions and PCL dampers may be applied to a myriad of substrates, in particular finding exemplary use in substrates of vehicles such as automobiles, and for other applications.

### BACKGROUND OF THE INVENTION

Panel constraining layer (PCL) dampers have been used, for example, in the automotive industry as noise and vibration transmission barriers around the passenger compartment for abating the engine and outside noise and deadening resonant vibrations transmitted into the compartment. PCL dampers are incorporated into panels surrounding the passenger compartment, such as in the dashboard as a “dash doubler,” the wheel housing as a “wheel-house doubler,” the doors, the roof, and other automotive parts. The performance and effectiveness of the PCL dampers affect the comfort and tranquility of the compartment occupant's driving experience. These assets are significant to consumers, and directly influence vehicle sales volume.

Applications for PCL dampers are not limited to the automobile industry. PCL dampers also are incorporated into industrial and residential machinery, business and computer equipment, household appliances, power tools, and the like used for noise and/or resonance vibration reduction. As with automobiles, the effectiveness of PCL dampers in each application strongly influences performance and sales.

PCL dampers are usually composed of a viscoelastic layer attached to a constraining layer. The constraining layer may be made of various materials, with steel perhaps being the most widely used material in the automotive industry. PCL dampers are preassembled using, for example, heat staking or mechanical fasteners to fix the viscoelastic layer and the constraining layer to one another. The preassembled PCL damper is joined to a substrate, such as a metal component in a manufacturing production line or in a body shop of automotive original equipment manufacturers (OEMs). The viscoelastic layer is not self-adhesive at room temperature. Consequently, conventional joining techniques such as welding and mechanical fastening are used to join the PCL damper to the substrate. The PCL is then heated, such as in an automotive body shop E-coat oven, to expand the viscoelastic layer sufficiently to fill a gap between the substrate and constraining layer, and to heat fuse the viscoelastic layer to the substrate and constraining layer. Baking also causes the viscoelastic layer to expand and to conform to the shape of the substrate.

Particularly in the automotive industry, the constraining layer is often made of a metal panel, typically about 0.5 mm in thickness. The typical viscoelastic layer has a thickness of 1 to 2 mm, and the typical steel constraining layer has a thickness of 0.5 to 1 mm. The resulting panel constrained layer damper exhibits good damping throughout a predetermined temperature range, possesses high stiffness, and, upon baking, provides good adhesion between the substrate and the constraining layer.

Examples of viscoelastic polymers routinely used in panel constrained layer dampers to provide damping performance include synthetic rubber such as SBS, SIS, and a tri-block copolymer including both styrene and vinyl bonded polyisoprene blocks with isoprene mid-blocks exhibiting extensive 3,4-polymerization, such as VS-1 from Kuraray Co. of Japan. See U.S. Pat. No. 5,635,562 and U.S. Pat. No. 6,110,895. Synthetic rubbers such as butyl rubber and SBR rubber are also used in damper compositions.

### SUMMARY OF THE INVENTION

According to a first aspect of the invention a viscoelastic composition is provided. The composition features an elastomeric polymeric component including an ethylene vinyl acetate polymer having a vinyl acetate content constituting about 60 weight percent or more of the ethylene vinyl acetate polymer, a thermoplastic polymeric component, asphalt resin, filler, and a blowing agent.

A second aspect of the invention provides a panel constrained layer damper featuring a viscoelastic layer attached to a constraining layer. The viscoelastic layer features an elastomeric polymeric component including an ethylene vinyl acetate polymer having a vinyl acetate content constituting about 60 weight percent or more of the ethylene vinyl acetate polymer, a thermoplastic polymeric component, asphalt resin, filler, and a blowing agent.

According to a third aspect of the invention, a damped structure including a panel constrained layer damper and a substrate is provided. The panel constrained layer damper includes a viscoelastic layer attached to a constraining layer. The viscoelastic layer features an elastomeric polymeric component including an ethylene vinyl acetate polymer having a vinyl acetate content constituting about 60 weight percent or more of the ethylene vinyl acetate polymer, a thermoplastic polymeric component, asphalt resin, filler, and a blowing agent.

A fourth aspect of the invention provides a method of damping a structure. According to the method, a panel constrained layer damper including a constraining layer and a viscoelastic layer is provided. The viscoelastic layer features an elastomeric polymeric component including an ethylene vinyl acetate polymer having a vinyl acetate content constituting about 60 weight percent or more of the ethylene vinyl acetate polymer, a thermoplastic polymeric component asphalt resin, filler, and a blowing agent. The panel constrained layer damper is heated to foam the viscoelastic layer and heat fuse the panel constrained layer damper to the substrate.

In the above aspects of the invention, the viscoelastic composition may contain additional ingredients, including one or more of an adhesion promoting resin, blowing agent, activator, and process aid. Additionally, the thermoplastic polymeric component may comprise an ethylene vinyl acetate polymer having a vinyl acetate content of 40 weight percent or less.

Additional aspects of the invention will become apparent upon viewing the accompanying drawings and reading the detailed description below.

### BRIEF DESCRIPTION OF THE DRAWINGS

The accompanying drawings are incorporated in and constitute a part of the specification. The drawings, together with the general description given above and the detailed description of the exemplary embodiment(s) and method(s) given below, serve to explain the principles of the invention. In such drawings:

FIG. 1 is a flowchart of a process for making a panel constrained layer damper according to an embodiment of the present invention;

FIG. 2 represents a process of heat fusing a panel constraining layer to a substrate according to an embodiment of the present invention;

FIG. 3 is a chart graphing the natural frequency and composite loss factors at multiple temperatures for specimens prepared according to Example 1;

FIG. 4 is a chart graphing the natural frequency and composite loss factors at multiple temperatures for specimens prepared according to Example 2; and

FIG. 5 is a chart graphing the natural frequency and composite loss factors at multiple temperatures for specimens prepared according to Example 3.

### DETAILED DESCRIPTION OF EXEMPLARY EMBODIMENT(S) AND EXEMPLARY METHOD(S) OF THE INVENTION

Reference will now be made in detail to exemplary embodiment(s) and method(s) of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the exemplary embodiments and methods.

The exemplary viscoelastic layers embodied herein are prepared from compositions including blends of one or more elastomeric polymeric components, one or more thermoplastic polymeric components, asphalt resin, one or more fillers, and one or more blowing agents. The constituents contribute damping properties over different temperatures. Collectively, the constituents provide the viscoelastic material with especially favorable damping properties over a broad range of temperature. Exemplary embodiments of the invention are characterized by composite loss factors (as measured by the damping test method described herein) above 0.1 at temperatures ranging from about 10° C. (50° F.) to above about 43° C. (110° F.). As shown by the examples below, in many instances the composite loss factor was measured above 0.1 across even broader temperature ranges, such as below about 4° C. (40° F.) to above about 60° C. (140° F.). As described herein, damping testing is performed with a 254 mm×20 mm×0.8 mm base bar, a 254 mm×20 mm×0.5 mm constraining layer, and a viscoelastic layer that is 1 mm before expansion, 2 mm after expansion. Both base bar and constraining layer are made of cold roll steel.

An exemplary elastomeric polymeric component of the present invention is selected to act as a sound barrier for reducing objectionable noise and concomitantly to reduce the normal resonant vibration amplitude. In an exemplary implementation the elastomeric polymeric component constitutes about 5 weight percent to about 50 weight percent, more preferably about 10 to about 25 weight percent of the overall weight of the viscoelastic composition.

The elastomeric polymeric component contains an ethylene vinyl acetate copolymer having a relatively high vinyl acetate content constituting at least about 60, 70, or 80 weight percent and up to about 90 weight percent of the total weight of the ethylene vinyl acetate copolymer. Ethylene vinyl acetate copolymers having a vinyl acetate content of about 60 to about 90 weight percent are available under the Levapren® rubber product line, such as Levapren® 600, 700, 800 and 900 (with VA content 60%, 70% 80% and 90%, respectively) manufactured by Lanxess® Corporation. Levapren® products are commercially described as ethylene vinyl acetate rubbers with a methylene main chain. The ethylene vinyl acetate elastomeric polymer may be used alone or in combination with additional natural and synthetic rubbers contributing to the elastomeric properties of the composition. Examples of additional rubbers include styrene butadiene copolymer, polyisobutylene, ethylene-propylene copolymer, EPDM terpolymer, and a tri-block copolymer including both styrene and vinyl bonded polyisoprene blocks with isoprene mid-blocks exhibiting extensive 3,4 polymerization.

The elastomeric polymeric component is blended with a thermoplastic polymeric component selected from a material or materials capable of improving the backbone strength of the viscoelastic layer. In exemplary embodiments the thermoplastic polymeric component constitutes, for example, about 5 weight percent to about 30 weight percent, more preferably about 10 to about 20 weight percent of the overall weight of the viscoelastic composition. The concentration of thermoplastic polymeric component may be selected to impart desired strength characteristics to the viscoelastic composition. In addition to improving the strength of the viscoelastic layer, the thermoplastic polymeric component may also be selected to improve low temperature damping properties of the layer.

An exemplary thermoplastic polymer component is a thermoplastic ethylene vinyl acetate polymer having a weight ratio of vinyl acetate constituting about 40 weight percent or less of the total weight of the ethylene vinyl acetate copolymer. In an exemplary embodiment, the vinyl acetate weight content is about 18 to about 28 weight percent of the ethylene vinyl acetate. Thermoplastic ethylene vinyl acetate has a lower glass transition temperature (T_{g}) than the elastomeric ethylene vinyl acetate. The lower T_{g} of the thermoplastic polymeric component improves the viscoelastic layer damping properties at lower temperatures than targeted by the elastomer. Thus, the viscoelastic layer expands the excellent damping properties of the viscoelastic layer over a broader temperature spectrum.

Other thermoplastic polymers that may be used in lieu of or in addition to the thermoplastic ethylene vinyl acetate include, for example, low density polyethylene (LDPE), polypropylene, other polyolefins, and other thermoplastics. By way of example, certain thermoplastic polymers marketed under ELVAX® by EI Dupont and ATEVA® by AT Plastics, Inc. may be used.

Asphalt is an excellent binder contained in the viscoelastic composition of Table 1 in a concentration of about 5 to about 20 weight percent, preferably about 10 to about 20 weight percent. Asphalt usually provides damping characteristics. The asphalt may be blown (straight-run) or unblown. A commercial asphalt acceptable for use herein is PIS 3417 from Trumbull.

The inorganic filler(s) may be selected to improve the damping and physical properties of the viscoelastic layer. Suitable fillers include calcium carbonate, dolomite, limestone, clay, talc, silica, silicates, minerals, other fillers, and combinations thereof. The filler may be present as finely divided particles having a size of, for example, 15-300 microns. In exemplary embodiments the fillers constitute about 25 to about 50 weight percent, more specifically about 30 to about 40 weight percent of the total weight of the viscoelastic composition.

The viscoelastic layer can be furnished with excellent foam properties by including one or more blowing agents in the composition. The blowing agent may yield gas by physical heating and/or chemical reaction. Exemplary blowing agents suitable for use with the embodied composition include azodicarbonamide, p,p′-oxybis-(benzene sulfonyl hydrazide), and other blowing agents known in the art, including commercially available blowing agents such as Celogen AZ, Celogen OT and other Celogens. The amount of blowing agent added to the composition may range, for example and not necessarily by limitation, from about 0.5 weight percent to about 8 weight percent, more preferably about 1 to about 5 weight percent of the total weight of the composition to impart desirable foam properties to the viscoelastic layer. In an exemplary embodiment, heating and/or chemical reaction of the blowing agent causes the viscoelastic layer to undergo a volume expansion of about 50 percent to about 300 percent, in particular about 100 percent to about 200 percent.

The viscoelastic composition may include additional components, such as adhesion promoting resins, activators and processing aids. Table 1 below sets forth an exemplary embodiment of a viscoelastic composition. It should be understood that the viscoelastic composition of the invention may in its broader aspects include some but not all of the ingredients set forth in Table 1, and further may include additional ingredients not listed in Table 1.

TABLE 1

| Ingredient | Range | Preferred |
|---|---|---|
| Elastomeric polymer | 5-50 wt % | 10-25 wt % |
| Thermoplastic polymer | 5-30 wt % | 10-20 wt % |
| Asphalt (resin) | 5-20 wt % | 10-20 wt % |
| Adhesion promoting resin | 1-20 wt % | 4-10 wt % |
| Inorganic filler | 25-50 wt % | 30-40 wt % |
| Blowing agent | 0.5-8 wt % | 1-5 wt % |
| Activator | 0.5-8 wt % | 2-4 wt % |
| Process aid | 0-20 wt % | 1-4 wt % |

The viscoelastic composition of Table 1 contains one or more adhesion promoting agents in an amount of about 1 to about 20 weight percent, preferably about 4 to about 10 weight percent. Desirably, the adhesion promoting agent(s) selected provide sufficient adhesion characteristics to promote fusion between the viscoelastic layer and both the constraining layer and the substrate to be damped, such as automotive grade sheet metal panels, after being heated to a sufficient temperature. Exemplary adhesion promoting agents include those selected from one or more from the following families: terpene resins, terpene-phenolic resins, phenolic resins, rosins, polyterpene resins, petroleum based C5 and C9 hydrocarbon resins, such as Wingtack® resins (e.g., Wingtack® 86 from Sartomer Company, Inc.), and phenolic resins (e.g., P90 from Akrochem Corporation).

Activators for activating blowing agents are well known in the art. Choice of activator may be based on the blowing agent selected. An exemplary activator suitable for use with blowing agents mentioned herein is zinc oxide (ZnO). Other activators may also be used. Activators range from about 0.5 to about 8 weight percent, more preferably about 2 to about 4 weight percent of the composition of Table 1.

A processing aid is incorporated into the composition of Table 1 in an amount of about 0 to about 20 weight percent, preferably about 1 to about 4 weight percent. Generally, processing aids improve compound processing without materially influencing the properties of the compounded materials. Improvements to the compound processing may involve shorter mixing time, reduced sticking to compounding equipment, less scorching, enhanced filler dispersion, and/or other benefits. An example of an excellent processing aid suitable for use in the viscoelastic composition is WB222 of Struktol Company of America, which is a highly concentrated, water-free blend of high molecular weight aliphatic fatty acid esters and condensation products.

Any suitable mixing equipment and techniques may be implemented to prepare the viscoelastic layers embodied herein. Roll mills, internal mixers, high shear mixers (e.g., Banbury), and other conventional rubber and plastic processing equipment may be used for blending the ingredients together. In exemplary embodiments the selected equipment and technique provide the viscoelastic layer with a substantially uniform distribution of ingredients and a substantially uniform porosity upon activation of the blowing agent.

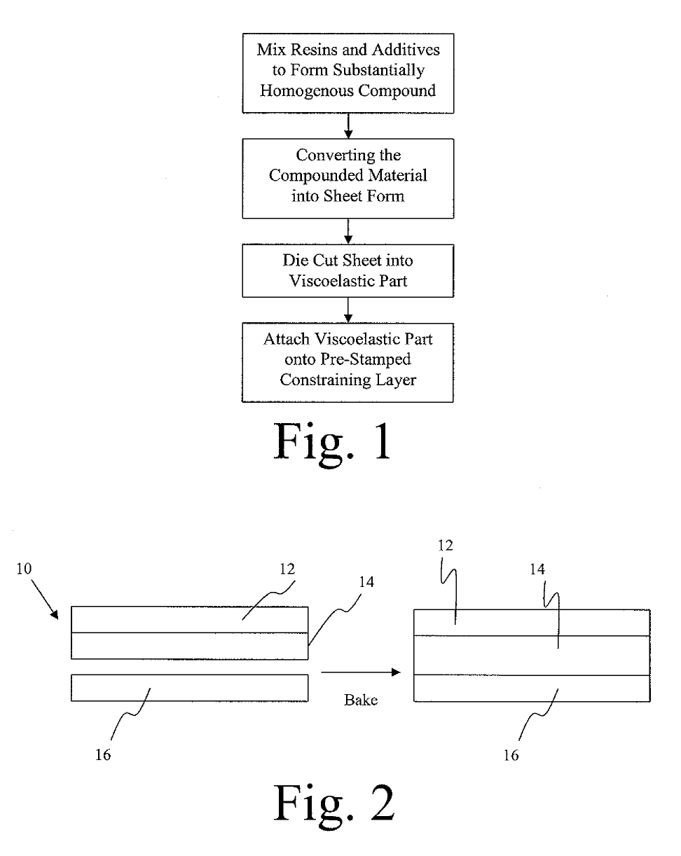

Referring to the exemplary embodiment illustrated in FIG. 1, in a mixing step the ingredients, with the exception of the blowing agent, are combined in any particular order and blended. No curative is required, although one or more may be added if desired. High shear mixers generally generate sufficient heat to facilitate blending, although an outside heat source may be used. For lower shear mixers, an outside heat source is preferably included to obtain a substantially homogenous mixture. The temperature applied at the blending stage is slightly higher, e.g., about 10° C. higher, than the melting point of the thermoplastic polymeric component. The blend is cooled, and the blowing agent is added to the blend and mixed substantially homogenously at a reduced temperature. The blend then is deposited as a viscoelastic sheet using a calender or extrusion process. The sheet is die cut into a shaped viscoelastic layer sized to match the size of a constraining layer on which the viscoelastic layer is to be deposited. The constraining layer may be pre-stamped to match the shape of a substrate, such as a wheel house or dashboard. Pre-stamping of the constraining layer may involve, for example, imparting bends and contours to the constraining layer so that it may be placed against and secured to the substrate. The deposited viscoelastic layer will conform to the shape of the constraining layer. The viscoelastic layer typically has a thickness of about 1 mm to about 2 mm. The thickness of the constraining layer typically ranges, for example, from about 0.5 mm to about 1.0 mm. The constraining layer may be made out of any suitable reinforcing material, especially metals such as steel and alloys. Because the viscoelastic layer is not self-adhesive, at least prior to baking, mechanical fasteners or heat staking may be used to attached the viscoelastic layer to the constraining layer.

FIG. 2 illustrates the joining of a panel constraining layer (PCL) damper 10 to a surface of a substrate 16. PCL damper 10 includes a constraining layer 12 and a viscoelastic layer 14. It should be understood that PCL damper 10 may contain multiple constraining layers and/or multiple viscoelastic layers. Viscoelastic layers may be placed one on another directly without interposing layers, or may be alternated with constraining layers. An exposed surface of viscoelastic layer 14 is placed adjacent to a surface of substrate 16. The facing surfaces are shown slightly spaced apart from one another to allow for expansion of the viscoelastic layer 14. Alternatively, viscoelastic layer 14 and substrate 16 may be placed in direct contact with one another. Mechanical fasteners are particularly useful for fixing PCL damper 10 and substrate 16 relative to one another prior to introducing PCL damper 10 and substrate 16 into the oven for baking.

The baking step illustrated in FIG. 2 serves to expand the viscoelastic layer 14 and causes viscoelastic layer 14 to heat fuse to substrate 16. Additionally, the beat of baking causes viscoelastic layer 14 to expand and to conform to the surface topography (e.g., contours) of constraining layer 12 and substrate 16 and to heat fuse constraining layer 12 to substrate 16. Expansion of viscoelastic layer 14 may be on the order of, for example, 100 to 200 percent. Hence, a 1 mm thick film may be expanded to about 2 mm to about 3 mm in thickness. The bake temperature is sufficiently high to expand and heat fuse viscoelastic layer 14. The bake temperature will typically range from about 150° C. to about 200° C. The time duration for baking will depend upon the selected temperature, but generally will range from about 20 to about 40 minutes. It should be understood that heating equipment other than a bake oven may be used.

The viscoelastic materials and PCL dampers embodied herein are particularly effective for applications in which metal constraining layers and metal substrates are employed. Specific examples of apparatus, assemblies, structures, and devices in which the viscoelastic materials of the present invention are particularly useful include vehicles, such as automobiles, planes, and maritime vessels; construction, such as interior and exterior metal wall panels; household appliances; industrial and commercial power tools; business and computer equipment; and others. The viscoelastic materials and PCL dampers of the present invention also find applicability for various non-metal apparatus, assemblies, structures, and devices, such as gypsum wall board, plywood, drywall, etc. In an automobile, for example, the materials embodied herein may be used in various panel sections, such as the door, roof, floor, hood, and other body sections.

The following examples serve to elucidate the principles and advantages of embodiments of the invention. The examples are presented by way of illustration, and are not to be considered exhaustive of the scope of the invention.

### EXAMPLES

The compositions of Examples 1-3 are set forth in Table 2 below. Percentages are by weight.

TABLE 2

| | 1 | 2 | 3 |
|---|---|---|---|
| Levapren ® 800 | 21.7% | 16.7% | 12.3% |
| Butyl rubber | 0.0% | 0.0% | 12.3% |
| EVA (18% VA) | 13.0% | 16.7% | 0.0% |
| LDPE | 0.0% | 0.0% | 12.3% |
| Asphalt | 13.0% | 16.7% | 12.3% |
| Wingtack 86 | 4.3% | 4.2% | 4.1% |
| Filler | 37.1% | 35.4% | 34.9% |
| ZnO | 3.5% | 3.3% | 3.3% |
| Stearic acid | 1.3% | 1.3% | 1.2% |
| Process aid | 1.7% | 1.7% | 0.0% |
| P90 | 0.0% | 0.0% | 4.1% |
| Celogen 754A | 2.2% | 2.0% | 2.1% |
| Celogen AZ130 | 2.2% | 2.0% | 1.1% |
| | 100.0% | 100.0% | 100.0% |

### Example 1

A mixer was preheated to 110° C., and loaded with 1193.5 grams of Levapren® 800, 715 g Elvax 460 (EVA, 18% VA from DuPont) and 236.5 g Wingtack 86 (from Sartomer). The loaded ingredients were mixed until pellets disappeared. 2040.5 g Dolofill 2055 filler, 715 g asphalt (PIS 3417 from Trumbull, asphalt was preheated to 80° C.), 192.5 g zinc oxide, 71.5 g stearic acid, 93.5 g WB222 were added and mixed until homogenous. The batch was cooled to below 93° C. (200° F.), then 121 g Celogen 754A and 121 g Celogen AZ130 were added. The material was mixed and discharged into a calender, where the batch was converted into sheet form.

The damping loss factor of a PCL damper having the viscoelastic layer of Example 1 was determined using the damping test of ASTM E756-04 Standard Test Method for Measuring Vibration-Damping Properties of Materials. For evaluation procedures, the base bar measured 254 mm×20 mm×0.8 mm, and the constraining layer of the tested sample measured 254 mm×20 mm×0.5 mm. Both base bar and constraining layer were made of cold roll steel. The polymer material thickness before expansion was 1 mm, and the final expanded polymer material thickness was 2 mm. The damping loss factor results for Example 1 are set forth in Table 3.

TABLE 3
(Example 1)

| | Mode 3/ | Mode 3/ | Mode 4/ | Mode 4/ | Mode 5/ | Mode 5/ | Mode 6/ | Mode 6/ |
|---|---|---|---|---|---|---|---|---|
| Temp (° F.) | NF | CLF | NF | CLF | NF | CLF | NF | CLF |
| 0.2 | 359.4 | 0.01 | 882.9 | 0.014 | 1513 | 0.019 | 2213.7 | 0.02 |
| 10.6 | 356.5 | 0.013 | 871 | 0.02 | 1487.5 | 0.026 | 2172.6 | 0.026 |
| 21.5 | 347.9 | 0.03 | 851.5 | 0.03 | 1447.9 | 0.036 | 2108.7 | 0.039 |
| 32.2 | 338.8 | 0.039 | 822.7 | 0.048 | 1391.7 | 0.055 | 2019.2 | 0.057 |
| 42.8 | 324.1 | 0.074 | 781.2 | 0.08 | 1314 | 0.089 | 1910.2 | 0.077 |
| 53.6 | 297.8 | 0.149 | 718.1 | 0.163 | 1195.9 | 0.158 | 1717.9 | 0.127 |
| 64.3 | 254.9 | 0.301 | 613.7 | 0.284 | 1035.9 | 0.271 | 1494.7 | 0.226 |
| 75 | 189 | 0.503 | 486.1 | 0.467 | 805 | 0.382 | | |
| 85.8 | 145.5 | 0.583 | 347.1 | 0.392 | 586 | 0.335 | | |
| 96.4 | | | 267.6 | 0.368 | 482.1 | 0.284 | 767.6 | 0.232 |
| 107.1 | | | 239.7 | 0.205 | 443.1 | 0.144 | 710 | 0.119 |
| 117.8 | 92.9 | 0.217 | 228.8 | 0.122 | 427.6 | 0.089 | 690.1 | 0.072 |
| 128.6 | 90.5 | 0.2 | 222.6 | 0.086 | 419.7 | 0.062 | 680.5 | 0.052 |

NF = natural (resonant) frequency (Hz)
CLF = composite loss factor

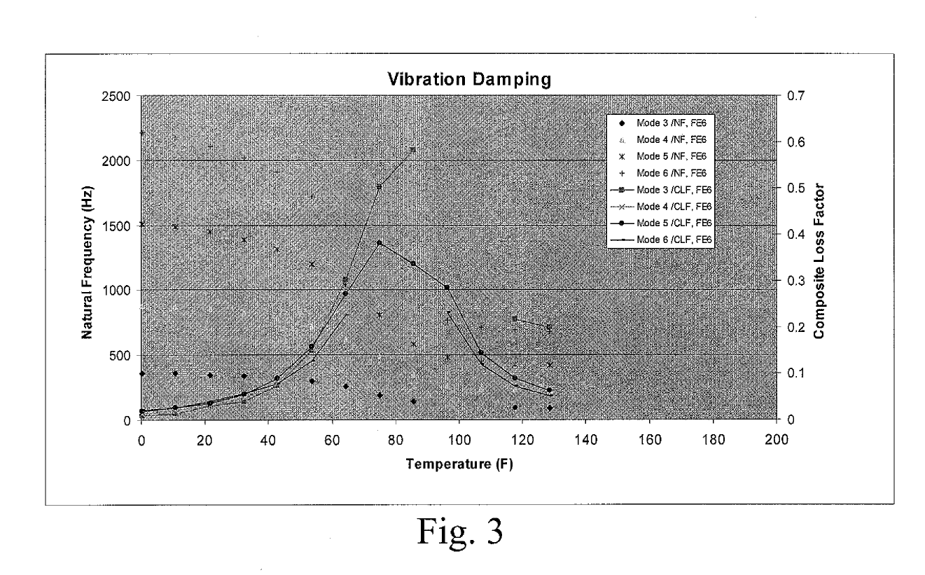

The results of Table 3 are graphed in FIG. 3. The graph illustrates that the PCL damper exhibited excellent damping properties over a broad range of temperature. The composite loss factor of the example was above 0.1 at temperatures ranging from below about 10° C. (50° F.) to above about 43° C. (110° F.). Damping properties across the broad temperature range was attributed to the concomitant use of the EVA elastomer, thermoplastic polymeric component, asphalt resin, filler, and blowing agent.

### Example 2

A mixer was preheated to 110° C. 918.5 g Levapren® 800, 918.5 g Elvax 460 (EVA, 18% VA from DuPont) and 231 g Wingtack 86 (from Sartomer) were added to the mixer and mixed until the pellets disappeared. 1947 g Dolofill 2055 filler, 918.5 g asphalt (PIS 3417 from Trumbull, asphalt was preheated to 80° C.), 181.5 g zinc oxide, 71.5 g stearic acid, 93.5 g WB222 were added and mixed until homogenous. The batch was cooled below 93° C. (200° F.), then 110 g Celogen 754A and 110 g Celogen AZ130 were added. The batch was mixed for 5 minutes then discharged into a calender, where the batch was converted into sheet form.

The damping loss factor of a PCL damper having the viscoelastic layer of Example 2 was determined using ASTM E756-04 Standard Test Method for Measuring Vibration-Damping Properties of Materials, and following the procedures described above with respect to Example 1. The results are set forth in Table 4 below.

TABLE 4
(Example 2)

| | Mode 3/ | Mode 3/ | Mode 4/ | Mode 4/ | Mode 5/ | Mode 5/ | Mode 6/ | Mode 6/ |
|---|---|---|---|---|---|---|---|---|
| Temp (° F.) | NF | CLF | NF | CLF | NF | CLF | NF | CLF |
| 19.7 | 395.6 | 0.038 | 983.4 | 0.073 | 1703.4 | 0.094 | 2512.7 | 0.088 |
| 32.3 | 380.5 | 0.065 | 926.6 | 0.111 | 1569.1 | 0.129 | 2306.7 | 0.111 |
| 44.6 | 353.9 | 0.122 | 834.1 | 0.191 | 1402.5 | 0.176 | 2061 | 0.163 |
| 56.9 | 311 | 0.251 | 692.3 | 0.329 | 1180 | 0.329 | 1734.3 | 0.31 |
| 69.4 | 233.1 | 0.392 | 515.3 | 0.497 | 862.1 | 0.46 | | |
| 81.9 | 198 | 0.332 | 411.3 | 0.361 | 671.7 | 0.404 | | |
| 94.1 | 168 | 0.263 | 350.5 | 0.263 | 568.8 | 0.24 | 866.7 | 0.219 |
| 106.6 | 144.2 | 0.204 | 301.8 | 0.249 | 496.7 | 0.182 | 761.8 | 0.164 |
| 131.5 | | | 253.8 | 0.134 | 435.5 | 0.119 | 681.9 | 0.113 |
| 143.7 | 110.7 | 0.151 | 240.1 | 0.115 | 417.5 | 0.101 | 659 | 0.091 |
| 180.9 | | | 204.6 | 0.083 | 375.9 | 0.078 | 612.9 | 0.073 |

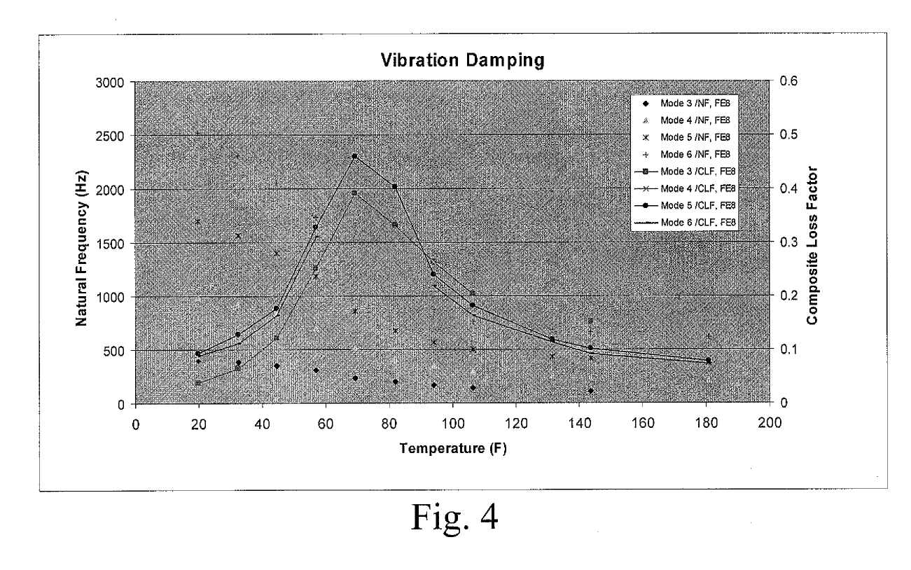

The results of Table 4 are graphed in FIG. 4. The graph illustrates that the PCL damper exhibited excellent damping properties over a broad range of temperature. The composite loss factor of the example was above 0.1 at temperatures ranging from about 4° C. (40° F.) to about 60° C. (140° F.). Damping properties across the broad temperature range was attributed to the concomitant use of the EVA elastomer, thermoplastic polymeric component, asphalt resin, filler, and blowing agent.

### Example 3

A mixer was preheated to 110° C. 676.5 g Levapren® 800, 676.5 g butyl rubber (blended butyl from Goldsmith and Eggleton, Inc) and 225.5 g Wingtack 86 (from Sartomer) were added to the mixer and mixed to homogeneity. 1919.5 g Dolofill 2055 filler, 676.5 g asphalt (PIS 3417 from Trumbull, asphalt was preheated to 80° C.), 181.5 g zinc oxide, 66 g stearic acid, and 225.5 g P90 resin (from Akrochem) were added and mixed until homogenous. The batch was cooled below 93° C. (200° F.), then 115.5 g Celogen 754A and 60.5 g Celogen AZ130 were added. The batch was further mixed for 5 minutes then discharged into a calender, where the batch was converted into sheet form.

The damping loss factor of a PCL damper having the viscoelastic layer of Example 3 was determined using ASTM E756-04 Standard Test Method for Measuring Vibration-Damping Properties of Materials, and following the procedures described above with respect to Example 1. The results are set forth in Table 5 below.

TABLE 5
(Example 3)

| | Mode 3/ | Mode 3/ | Mode 4/ | Mode 4/ | Mode 5/ | Mode 5/ | Mode 6/ | Mode 6/ |
|---|---|---|---|---|---|---|---|---|
| Temp (° F.) | NF | CLF | NF | CLF | NF | CLF | NF | CLF |
| 19.9 | 303.1 | 0.103 | 722.1 | 0.173 | 1214.7 | 0.179 | 1806.5 | 0.151 |
| 32.1 | 291.2 | 0.117 | 682.1 | 0.192 | 1136.5 | 0.203 | 1693.8 | 0.168 |
| 44.5 | 273.7 | 0.153 | 625.9 | 0.224 | 104.8 | 0.213 | 1545.2 | 0.23 |
| 57 | 246.8 | 0.219 | 553.9 | 0.301 | 931 | 0.271 | 1371.9 | 0.269 |
| 69.4 | 210.6 | 0.325 | 467.3 | 0.379 | 804.9 | 0.322 | 1186 | 0.3 |
| 81.9 | 180.9 | 0.334 | 399.9 | 0.337 | 679.3 | 0.341 | 1029.5 | 0.306 |
| 94.3 | 160.7 | 0.297 | 352.5 | 0.269 | 594 | 0.224 | 917.7 | 0.237 |
| 106.6 | 141.3 | 0.255 | 312.7 | 0.236 | 531.2 | 0.198 | 814.8 | 0.178 |
| 118.9 | 126.6 | 0.235 | 284.4 | 0.202 | 493.1 | 0.169 | 762.6 | 0.15 |
| 134.1 | 118.8 | 0.225 | 265.9 | 0.194 | 468.5 | 0.145 | 733.3 | 0.136 |
| 143.8 | 113 | 0.191 | 253.5 | 0.15 | 452.4 | 0.126 | 708.9 | 0.119 |
| 156.1 | 106.5 | 0.18 | 243.3 | 0.123 | 438.3 | 0.109 | 691.1 | 0.109 |
| 168.5 | 99.5 | 0.147 | 234.1 | 0.108 | 425.8 | 0.096 | 675.1 | 0.096 |
| 181 | 93.6 | 0.151 | 225.8 | 0.094 | 451.5 | 0.084 | 662.7 | 0.085 |

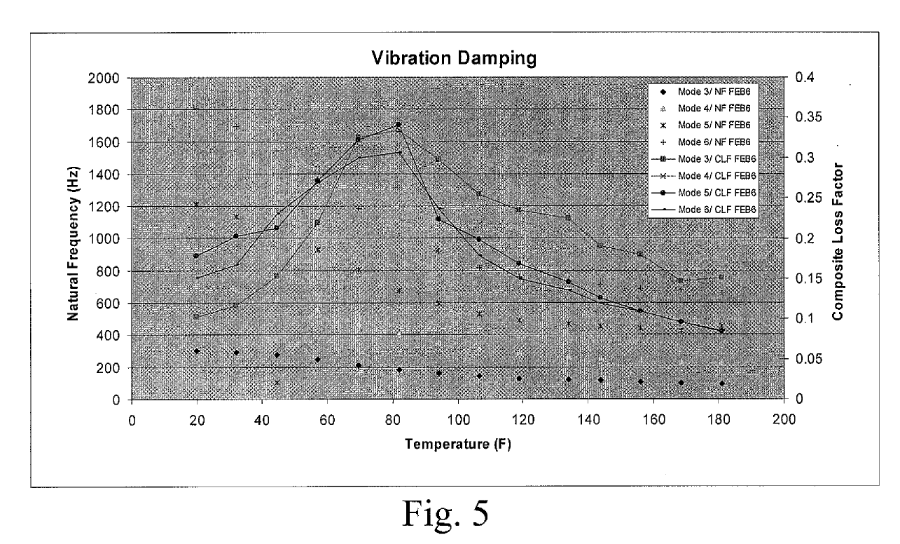

The results of Table 5 are graphed in FIG. 5. The graph illustrates that the PCL damper exhibited excellent damping properties over a broad range of temperature. The composite loss factor of the example was above 0.1 at temperatures ranging from below about 2° C. (35° F.) to above about 66° C. (150° F.). Damping properties across the broad temperature range was attributed to the concomitant use of the EVA and another elastomer, thermoplastic polymeric component, asphalt resin, filler, and blowing agent.

The foregoing detailed description of the certain exemplary embodiments of the invention has been provided for the purpose of explaining the principles of the invention and its practical application, thereby enabling others skilled in the art to understand the invention for various embodiments and with various modifications as are suited to the particular use contemplated. This description is not intended to be exhaustive or to limit the invention to the precise embodiments disclosed. Modifications and equivalents will be apparent to practitioners skilled in this art and are encompassed within the spirit and scope of the appended claims and their appropriate equivalents.

What is claimed is:

1. A viscoelastic composition comprising an elastomeric polymeric component including an ethylene vinyl acetate polymer with a vinyl acetate content constituting about 60 weight percent or more of the ethylene vinyl acetate polymer, a thermoplastic polymeric component, asphalt resin, filler, and a blowing agent.

2. The viscoelastic composition of claim 1, wherein the composition, when situated as a viscoelastic layer on a steel constraining layer, is characterized by a composite loss factor above 0.1 throughout a temperature range of about 10° C. to about 43° C.

3. The viscoelastic composition of claim 1, wherein the vinyl acetate content is about 90 weight percent or less of the ethylene vinyl acetate polymer.

4. The viscoelastic composition of claim 1, wherein the thermoplastic polymer component comprises an ethylene vinyl acetate polymer having a vinyl acetate content constituting about 40 weight percent or less of the ethylene vinyl acetate polymer of the thermoplastic polymer component.

5. The viscoelastic composition of claim 1, wherein:
the elastomeric polymeric compound constitutes about 5 to about 50 weight percent of the viscoelastic composition; and
the thermoplastic polymeric component constitutes about 5 to about 30 weight percent of the viscoelastic composition.

6. The viscoelastic composition of claim 5, wherein:
the asphalt resin constitutes about 5 to about 20 weight percent of the viscoelastic composition;
the filler constitutes about 25 to about 50 weight percent of the viscoelastic composition; and
the blowing agent constitutes about 0.5 to about 8 weight percent of the viscoelastic composition.

7. The viscoelastic composition of claim 6, further comprising;
about 1 to about 20 weight percent adhesion promoting resin,
about 0.5 to about 8 weight percent activator, and
about 0 to about 20 weight percent process aid.

8. The viscoelastic composition of claim 1, wherein the elastomeric polymeric component further comprises at least one member selected from the group consisting of styrene butadiene copolymer, polyisobutylene, ethylene-propylene copolymer, and EPDM terpolymer.

9. A panel constrained layer damper comprising;
a constraining layer, and
a viscoelastic layer attached to the constraining layer, the viscoelastic layer comprising an elastomeric polymeric component including an ethylene vinyl acetate polymer with a vinyl acetate content constituting about 60 weight percent or more of the ethylene vinyl acetate polymer, a thermoplastic polymeric component, asphalt resin, filler, and a blowing agent.

10. The panel constrained layer damper of claim 9, wherein the viscoelastic layer is characterized by a composite loss factor above 0.1 throughout a temperature range of about 10° C. to about 43° C.

11. The panel constrained layer damper of claim 9 wherein the vinyl acetate content is about 90 weight percent or less of the ethylene vinyl acetate polymer.

12. The panel constrained layer damper of claim 9, wherein the thermoplastic polymeric component comprises ethylene vinyl acetate polymer with a vinyl acetate content constituting about 40 weight percent or less of the ethylene vinyl acetate polymer of the thermoplastic polymeric component.

13. The panel constrained layer damper of claim 9, wherein:
the elastomeric polymeric compound constitutes about 5 to about 50 weight percent of the viscoelastic layer; and
the thermoplastic polymeric component constitutes about 5 to about 30 weight percent of the viscoelastic layer.

14. The panel constrained layer damper of claim 13, wherein:
the asphalt resin constitutes about 5 to about 20 weight percent of the viscoelastic layer;
the filler constitutes about 25 to about 50 weight percent of the viscoelastic layer; and
the blowing agent constitutes about 0.5 to about 8 weight percent of the viscoelastic layer.

15. The panel constrained layer damper of claim 14, further comprising:
about 1 to about 20 weight percent adhesion promoting resin,
about 0.5 to about 8 weight percent activator, and
about 0 to about 20 weight percent process aid.

16. The panel constrained layer damper of claim 9, wherein the elastomeric polymeric component her comprises at least one member selected from the group consisting of styrene butadiene copolymer, polyisobutylene, ethylene-propylene copolymer, and EPDM terpolymer.

17. The panel constrained layer damper of claim 9, wherein the constraining layer comprises steel.

18. A damped structure comprising:
a substrate to be damped; and
a panel constrained layer damper joined to the substrate, the panel constrained layer damper comprising a constraining layer and a viscoelastic layer attached to the constraining layer, the viscoelastic layer comprising an elastomeric polymeric component including an ethylene vinyl acetate polymer with a vinyl acetate content constituting about 60 weight percent or more of the ethylene vinyl acetate polymer, a thermoplastic polymeric component, asphalt resin, filler, and a blowing agent.

19. The damped structure of claim 18, wherein the viscoelastic layer is characterized by a composite loss factor above 0.1 throughout a temperature range of about 10° C. to about 43° C.

20. A method of damping a structure, comprising;
providing a panel constrained layer damper comprising a constraining layer and a viscoelastic layer, the viscoelastic layer comprising an elastomeric polymeric component including an ethylene vinyl acetate polymer with a vinyl acetate content constituting about 60 weight percent or more of the ethylene vinyl acetate polymer, a thermoplastic polymeric component, asphalt resin, filler, and a blowing agent; and
heating the panel constrained layer damper to foam the viscoelastic layer to heat fuse the panel constrained layer damper to the substrate.

21. An automotive panel comprising:
a steel substrate to be damped; and
a panel constrained layer damper fused to the substrate, the panel constrained layer damper comprising a constraining layer and a viscoelastic layer attached to the constraining layer, the viscoelastic layer comprising an elastomeric polymeric component including an ethylene vinyl acetate polymer with a vinyl acetate content constituting about 60 weight percent or more of the ethylene vinyl acetate polymer, a thermoplastic polymeric component, asphalt resin, filler, and a blowing agent.
